(19) United States
(12) Patent Application Publication
(10) Pub. No.: US 2020/0189085 A1
(43) Pub. Date: Jun. 18, 2020

(54) Valve of Pneumatic Hammer

(71) Applicant: Ching-Tien Lin, Taichung City (TW)

(72) Inventor: Ching-Tien Lin, Taichung City (TW)

(21) Appl. No.: 16/220,277

(22) Filed: Dec. 14, 2018

(51) Int. Cl. B25D 9/20; F16K 31/122; F01L 21/04

(52) U.S. Cl. CPC B25D 9/20; F01L 21/04; F16K 31/122

(57) ABSTRACT

A valve of a pneumatic hammer include a rear mechanism including two opposite inlets, a chamber member, outlets, a relief chamber communicating with the outlets, two opposite inlet channels disposed externally of the chamber member, and two first outlet tunnels disposed externally of the chamber member wherein one end of the relief chamber communicates with the first outlet tunnels, the first outlet tunnels are disposed externally of the relief chamber and pass through the rear mechanism, and the inlets communicate with the inlet channels and the outlets; a front mechanism including a chamber element communicating with the inlet channels, an axial tunnel through a center of the chamber element, and two second outlet tunnels disposed externally of the chamber element, the second outlet tunnels corresponding to and communicating with the first outlet tunnels; and a disc between the chamber member and the chamber element.

### BACKGROUND OF THE INVENTION

### 1. Field of the Invention

The invention relates to pneumatic hammers and more particularly to a pneumatic hammer comprising a valve including a rear mechanism having first outlet tunnels, a front mechanism having second outlet tunnels, both the first and second outlet tunnels communicating with inlets so that the compressed air supplied from the inlets flows into an operating cylinder to push a piston forward in a hammering operation, the piston movement being smooth with a minimum friction and the hammering effect being increased greatly.

### 2. Description of Related Art

Conventionally, a valve of a pneumatic hammer is provided with an outlet. The compressed air may flow out of an operating cylinder via the outlet. However, a piston in the operating cylinder may not move back and forth smoothly due to unbalanced impact of the compressed air onto the piston. As a result, wear is great, the hammering effect of the pneumatic hammer is poor, and the pneumatic hammer is not durable.

Thus, the need for improvement still exists.

### SUMMARY OF THE INVENTION

It is therefore one object of the invention to provide a valve of a pneumatic hammer, comprising a rear mechanism including two opposite inlets, a chamber member, a plurality of outlets, a relief chamber communicating with the outlets, two opposite inlet channels disposed externally of the chamber member, and two first outlet tunnels disposed externally of the chamber member wherein one end of the relief chamber distal the chamber member communicates with the first outlet tunnels, the first outlet tunnels are disposed externally of the relief chamber and pass through the rear mechanism, and the inlets communicate with the inlet channels and the outlets; a front mechanism secured to the rear mechanism and including a chamber element on one surface corresponding to the chamber member, the chamber element communicating with the inlet channels, an axial tunnel disposed through a center of the chamber element, and two second outlet tunnels disposed externally of the chamber element, the second outlet tunnels corresponding to and communicating with the first outlet tunnels; and a disc disposed between the chamber member and the chamber element.

The invention has the following advantages and benefits in comparison with the conventional art: the compressed air supplied from the inlets flows into an operating cylinder via the first and second outlet tunnels and two longitudinal inlet passageways besides the operating cylinder. And in turn, the compressed air in an axial space of the operating cylinder strongly pushes a piston forward. Also, the movement is smooth with a minimum friction. Further, the hammering effect is increased greatly.

The above and other objects, features and advantages of the invention will become apparent from the following detailed description taken with the accompanying drawings.

### BRIEF DESCRIPTION OF THE DRAWINGS

FIG. 1 is a perspective view of a valve according to the invention, the valve being ready to install in a pneumatic hammer;

FIG. 2 is an exploded view of FIG. 1;

FIG. 3 is a sectional view taken along line 3-3 of FIG. 1;

FIG. 4 is a sectional view taken along line 4-4 of FIG. 1;

FIG. 5 is a perspective view of an operating cylinder with the valve mounted at a rear end of the operating cylinder;

FIG. 5A is a detailed view of the area in a circle shown in FIG. 5 showing the rear mechanism from a rear end;

FIG. 6 is a sectional view taken along line 6-6 of FIG. 5 showing a rearward movement of the piston in the operating cylinder;

FIG. 6A is a detailed view of the area in a circle shown in FIG. 6;

FIG. 7 is a view similar to FIG. 6 showing an initial stage of a forward movement of the piston in the operating cylinder;

FIG. 7A is a detailed view of the area in a circle shown in FIG. 7;

FIG. 8 is a view similar to FIG. 7 showing a final stage of the forward movement of the piston in the operating cylinder;

FIG. 8A is a detailed view of the area in a circle shown in FIG. 8;

FIG. 9 is a sectional view taken along line 9-9 of FIG. 5 showing a rearward movement of the piston in the operating cylinder after a portion of the compressed air being released;

FIG. 9A is a detailed view of the area in a circle shown in FIG. 9; and

FIG. 10 is a perspective view of a pneumatic hammer incorporating the valve.

### DETAILED DESCRIPTION OF THE INVENTION

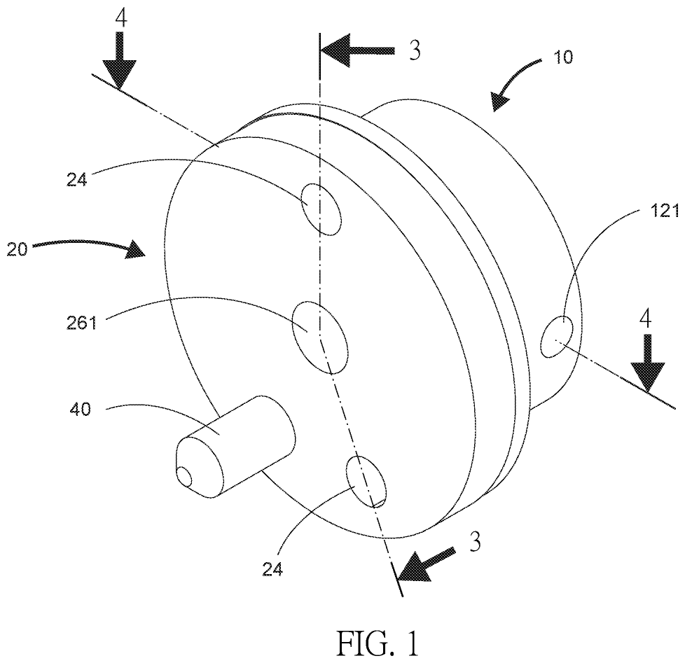

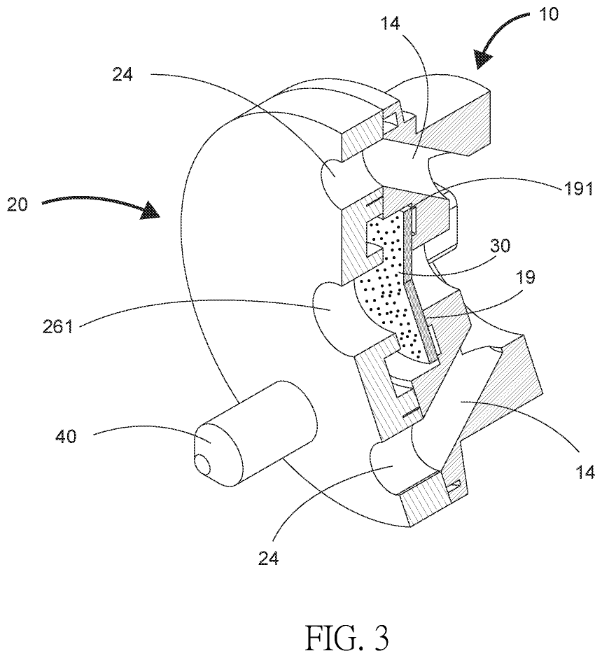

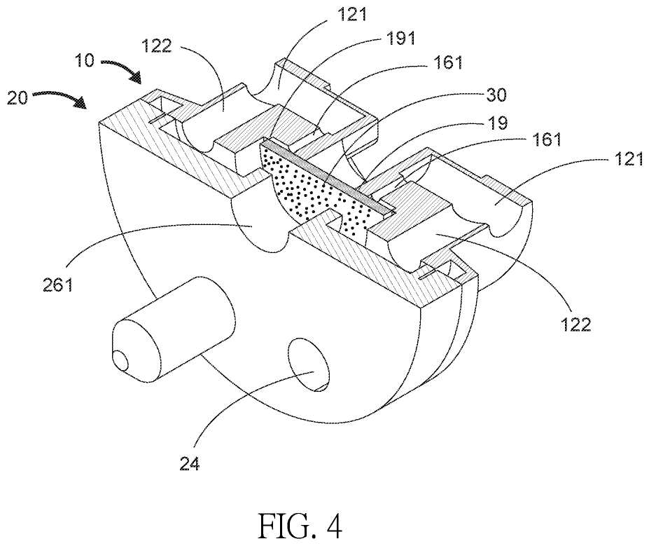

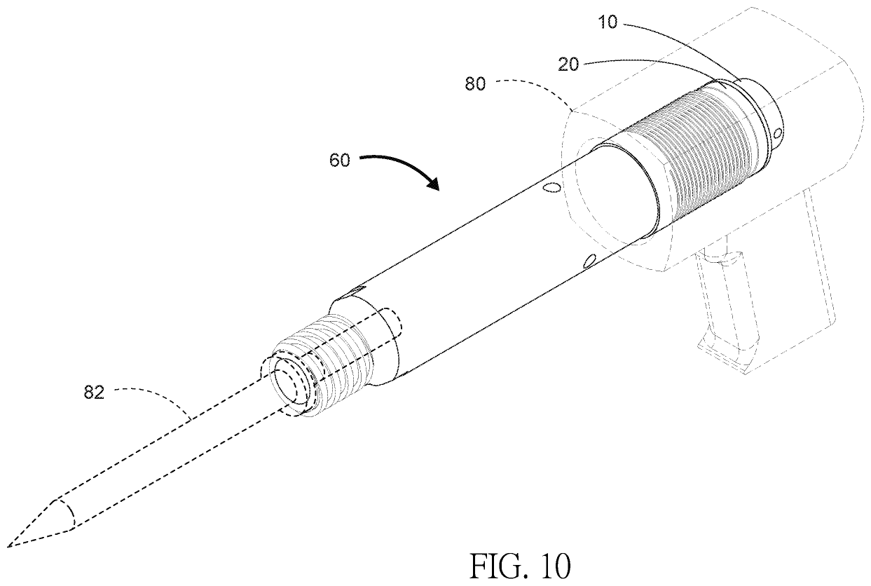

Referring to FIGS. 1 to 10, a valve of a pneumatic hammer 80 in accordance with the invention is shown. The valve comprises a rear mechanism 10, a front mechanism 20 and a disc 30.

The rear mechanism 10 includes two opposite inlets 121, a chamber member 16, a plurality of outlets 161 and a relief chamber 17 communicating with the outlets 161. An annular guide 19 is provided between the outlets 161 and the relief chamber 17. Two opposite inlet channels 122 and two first outlet tunnels 14 are provided externally of the chamber member 16. An annular flange 191 is formed on an inner surface of the chamber member 16 and is adjacent to the outlets 161. The end of the relief chamber 17 distal the chamber member 16 communicates with the first outlet tunnels 14. The first outlet tunnels 14 are externally of the relief chamber 17 and pass through the rear mechanism 10. The inlets 121 communicate with the inlet channels 122 and the outlets 161.

The front mechanism 20 is secured to the rear mechanism 10 and includes a chamber element 26 on one surface corresponding to the chamber member 16. The chamber element 26 communicates with the inlet channels 122. An axial tunnel 261 is provided through a center of the chamber element 26. An annular guide member 262 is provided around the axial tunnel 261, the annular guide member 262 having a diameter less than that of the chamber member 16. Two second outlet tunnels 24 are provided externally of the chamber element 26. The second outlet tunnels 24 correspond to and communicate with the first outlet tunnels 14.

The disc 30 is disposed between the chamber member 16 and the chamber element 26.

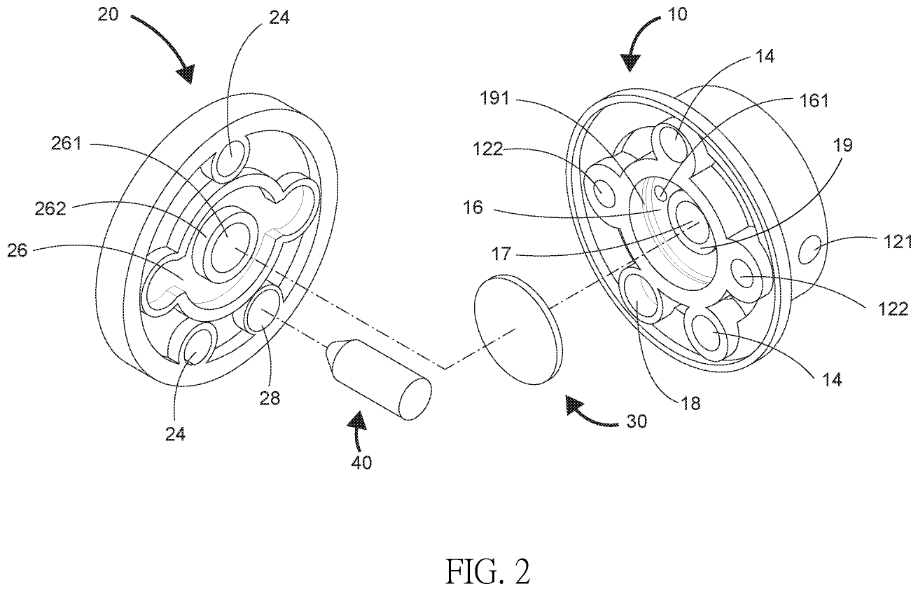

As shown in FIGS. 2 to 4 specifically, a first hole 18 is provided externally of the chamber member 16 and a second hole 28 corresponding to the first hole 18 is provided externally of the chamber element 26. A pin 40 is inserted through the first and second holes 18 and 28 to fasten the rear mechanism 10 and the front mechanism 20 together.

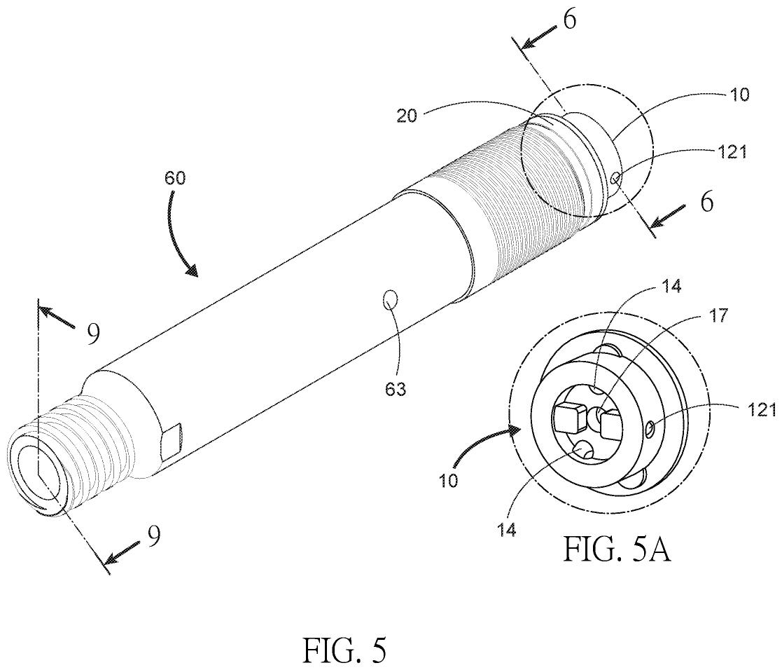

As shown in FIGS. 2, 5, and 5A specifically, the valve is mounted at a rear end of an operating cylinder 60 (i.e., the front mechanism 20 urging against the operating cylinder 60) so that compressed air may enter the operating cylinder 60 via the inlets 121. As shown in FIG. 5A, a rear end of the rear mechanism 10 projects with the relief chamber 17 formed through its center. The first outlet tunnels 14 are provided externally of the relief chamber 17.

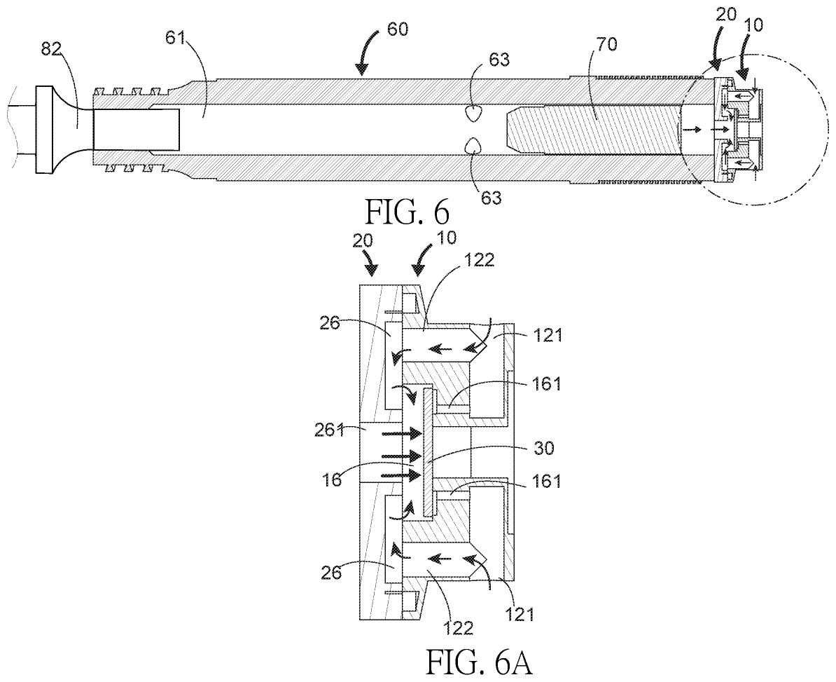

As shown in FIGS. 6 to 10 specifically, the valve is mounted at a rear portion of the pneumatic hammer 80 with a substantial portion of the operating cylinder 60 being projected. A tool bit 82 is secured to a front end of the operating cylinder 60. The front mechanism 20 urges against the operating cylinder 60. The operating cylinder 60 includes an axial space 61 and a plurality of intermediate holes 63 through a surface and communicating with the axial space 61. A piston 70 is slidably disposed in the axial space 61. Two longitudinal inlet passageways 62 are provided in the operating cylinder 60 with the axial space 61 disposed therebetween. The rear mechanism 10 is secured to the front mechanism 20. The disc 30 is moveably disposed in the chamber member 16 so that the inlets 121, the outlets 161, the chamber element 26 and the axial tunnel 261 communicate one another. The piston 70 may reciprocate to strike the tool bit 82. As a result, the tool bit 82 may repeatedly hit a target.

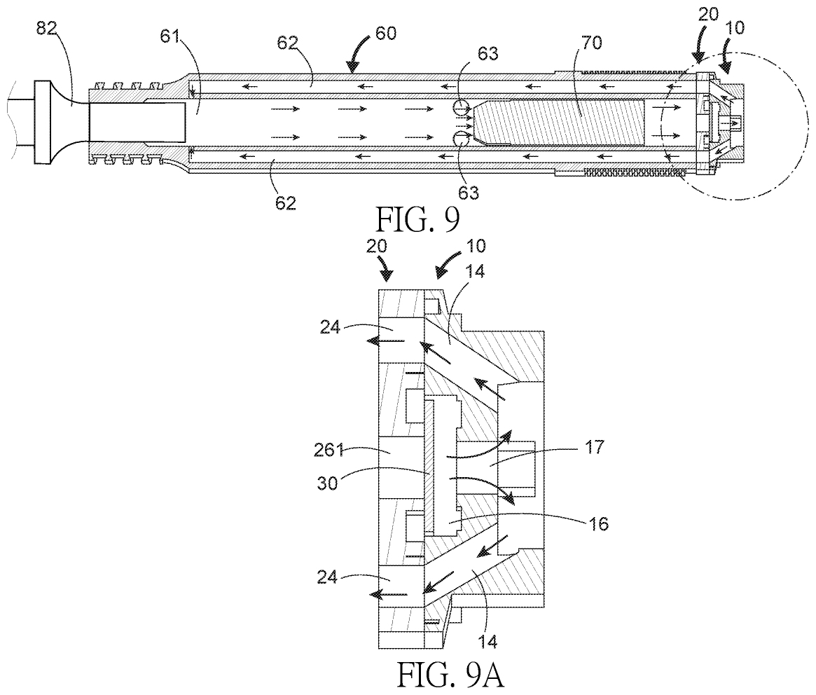

As shown in FIG. 9 specifically, one ends of the inlet passageways 62 communicate with the axial space 61 and the other ends thereof communicate with the second outlet tunnels 24 which pass through the front mechanism 20.

As shown in FIGS. 6, 6A, and 2 specifically, when the piston 70 moves toward the front mechanism 20 (i.e., rearward movement), compressed air may press the disc 30. And in turn, the disc 30 rearward moves to push the rear mechanism 10 until the disc 30 contacts the rear mechanism 10. As a result, compressed air is supplied to the inlets 121.

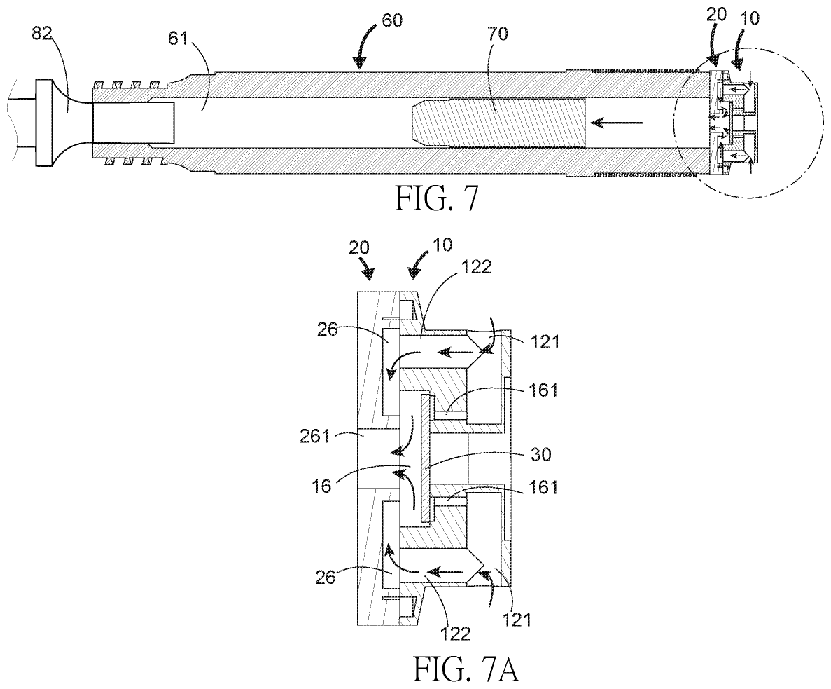

As shown in FIGS. 7, 7A, and 2 specifically, the compressed air supplied from the inlets 121 may flow to the axial tunnel 261 via the inlet channels 122. And in turn, the compressed air flows to the axial space 61 of the operating cylinder 60 to push the piston 70 away from the front mechanism 20 (i.e., an initial stage of a forward movement).

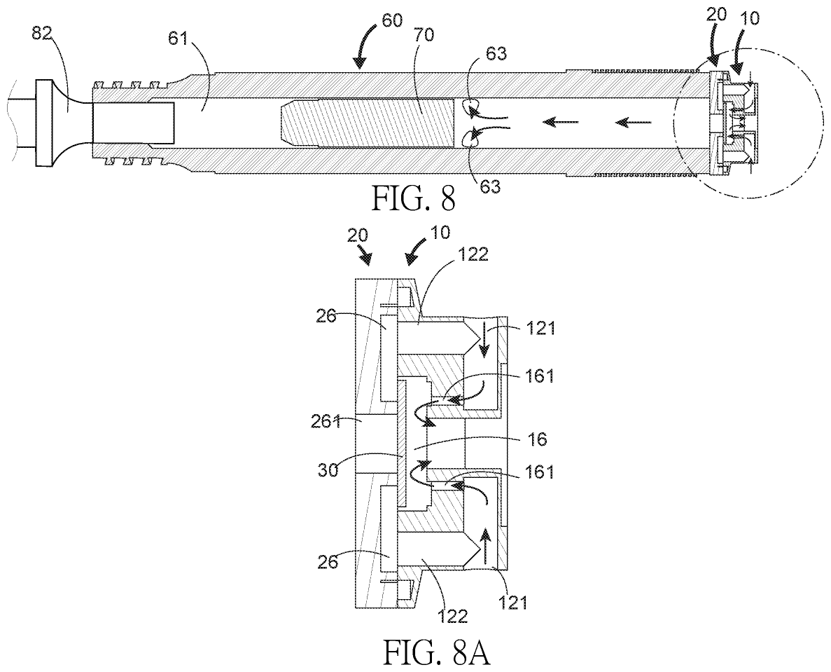

As shown in FIGS. 8, 8A, and 2 specifically, the piston 70 further moves away from the front mechanism 20 (i.e., further moving forward) to pass the intermediate holes 63. As such, a portion of the compressed air flows through the intermediate holes 63 to release to slowly stop the forward movement of the piston 70. And in turn, the compressed air no more flows to the axial tunnel 261 to push the disc 30. As a result, the disc 30 urges against the front mechanism 20.

As shown in FIGS. 9, 9A, 10, and 2 specifically, the compressed air from the inlets 121 flows to the outlets 161. And in turn, the compressed air flows to the relief chamber 17 via the outlets 161 due to the closure of the front mechanism 20 by the disc 30. Further, the compressed air flows to the inlet passageways 62 of the operating cylinder 60 via the first outlet tunnels 14 and the second outlet tunnels 24. Furthermore, the compressed air flows from the ends of the inlet passageways 62 distal the front mechanism 20 to the axial space 61. It is noted that the inlet passageways 62 are symmetric with respect to the axial space 61. Thus, the compressed air may stably and strongly push the piston 70 toward the front mechanism 20 (i.e., moving rearward) smoothly with a minimum friction. A portion of the compressed air may release to the intermediate holes 63 after the piston 70 has passed the intermediate holes 63. The strength of the compressed air is decreased but the compressed air is still capable of moving the disc 30 toward the rear mechanism 10. The operations described in FIGS. 6 to 9 are repeated (i.e., the piston 70 reciprocating) to hammer the tool bit 82 toward a target.

While the invention has been described in terms of preferred embodiments, those skilled in the art will recognize that the invention can be practiced with modifications within the spirit and scope of the appended claims.

What is claimed is:

1. A valve of a pneumatic hammer, comprising:
a rear mechanism including two opposite inlets, a chamber member, a plurality of outlets, a relief chamber communicating with the outlets, two opposite inlet channels disposed externally of the chamber member, and two first outlet tunnels disposed externally of the chamber member wherein one end of the relief chamber distal the chamber member communicates with the first outlet tunnels, the first outlet tunnels are disposed externally of the relief chamber and pass through the rear mechanism, and the inlets communicate with the inlet channels and the outlets;
a front mechanism secured to the rear mechanism and including a chamber element on one surface corresponding to the chamber member, the chamber element communicating with the inlet channels, an axial tunnel disposed through a center of the chamber element, and two second outlet tunnels disposed externally of the chamber element, the second outlet tunnels corresponding to and communicating with the first outlet tunnels; and
a disc disposed between the chamber member and the chamber element.

2. The valve of claim 1, further comprising an annular guide disposed between the outlets and the relief chamber.

3. The valve of claim 1, further comprising an annular flange disposed on an inner surface of the chamber member, the annular flange being adjacent to the outlets.

4. The valve of claim 1, further comprising an annular guide member disposed around the axial tunnel, the annular guide member having a diameter less than a diameter of the chamber member.

5. The valve of claim 1, further comprising a first hole disposed externally of the chamber member, a second hole disposed externally of the chamber element, the second hole corresponding to the first hole, and a pin inserted through the first and second holes to fasten the rear mechanism and the front mechanism together.
